(19) United States
(12) Patent Application Publication
(10) Pub. No.: US 2008/0016193 A1
(43) Pub. Date: Jan. 17, 2008

(54) COORDINATED UPLOAD OF CONTENT FROM DISTRIBUTED MULTIMEDIA CAPTURE DEVICES

(76) Inventors: Geoffrey Benjamin Allen, Potomac Falls, VA (US); Steven Lee Geyer, Herndon, VA (US)

Correspondence Address: COOLEY GODWARD KRONISH LLP;ATTN: PATENT GROUP, Suite 1100, 777 - 6th Street, NW, WASHINGTON, DC, 20001, US

(21) Appl. No.: 11/457,887

(22) Filed: Jul. 17, 2006

(51) Int. Cl. G06F 15/16; G06F 15/173

(52) U.S. Cl. 709/223; 709/203

(57) ABSTRACT

In one embodiment, a method includes receiving, at a control server, a local parameter value and/or a regional parameter value. The local parameter value is associated with a multimedia capture device within a network and the regional parameter value is associated with at least two entities of the network. A transmission rule having a local component and a regional component is received at the control server. The local component is associated with the multimedia capture device and the regional component is associated with the at least two entities of the network. A transmission indicator is sent from the control server to the multimedia capture device. The transmission indicator is based on the transmission rule and on the local parameter value and/or the regional parameter value. The transmission indicator is configured to cause the multimedia capture device to modify sending a media signal over the network.

### RELATED APPLICATION

This application is related to U.S. Patent Application Attorney Docket ANYS-004/00US, entitled “Coordinated Upload of Content from Multimedia Capture Devices Based on a Transmission Rule,” filed on even date herewith, which is incorporated herein by reference in its entirety.

### FIELD OF INVENTION

The invention relates generally to an apparatus and method for uploading media signals, and more particularly, to an apparatus and method for uploading media signals captured from a multimedia capture device.

### BACKGROUND

The ability to capture live media recordings of, for example, meetings and/or classroom instruction for time-shifted viewing and on-demand availability has become valuable to institutions such as universities and businesses. Accordingly, to accommodate the demand for time-shifted viewing and on-demand availability, capture devices can be distributed across a network to capture/process media content and upload/send the media content to a central location for later distribution. Coordinating the capturing and uploading of media content from a few capture devices in a small network can be straightforward in many environments. But, in large networks (e.g., multi-purpose networks) that include numerous distributed capture devices, the uploading of sizeable quantities of captured media content to one or more centralized locations can cause a significant degradation of network functionality. Thus, a need exists for an apparatus and method for coordinating the uploading of captured media content over a network.

### SUMMARY OF THE INVENTION

In one embodiment, a method includes receiving, at a control server, a local parameter value and/or a regional parameter value. The local parameter value is associated with a multimedia capture device within a network and the regional parameter value is associated with at least two entities of the network. A transmission rule having a local component and a regional component is received at the control server. The local component is associated with the multimedia capture device and the regional component is associated with the at least two entities of the network. A transmission indicator is sent from the control server to the multimedia capture device. The transmission indicator is based on the transmission rule and on the local parameter value and/or the regional parameter value. The transmission indicator is configured to cause the multimedia capture device to modify sending a media signal over the network.

### BRIEF DESCRIPTION OF THE DRAWINGS

FIG. 1 is a system block diagram that illustrates multimedia capture devices connected to a control server over a network, according to an embodiment of the invention.

FIG. 2 shows a table that illustrates a transmission rule that can be used to define a transmission rate for several multimedia capture devices, according to an embodiment of the invention.

FIG. 3 shows a flowchart that illustrates a method for using a transmission rule to trigger the uploading of a media signal from a multimedia capture device, according to an embodiment of the invention.

FIG. 4 is a schematic system block diagram that illustrates multimedia capture devices connected with a control server over a network, according to another embodiment of the invention.

FIG. 5 shows a flowchart that illustrates a method for using a first transmission rule to define a second transmission rule, according to an embodiment of the invention.

### DETAILED DESCRIPTION

A multimedia capture device (MCD) is a device configured to capture, process, store and/or send real-time media signals (e.g., audio signal, video signal, visual-capture signal, and/or digital-image signal) of, for example, an in-progress classroom presentation. The multimedia capture device can be, for example, an embedded appliance dedicated to real-time media signal capture or a general purpose computer system configured for real-time media signal capture. A real-time media signal represents an image and/or a sound of an event that is being acquired by a sensor (i.e., media sensor) at substantially the same time as the event is occurring and that is transmitted without a perceptible delay between the sensor when acquired and the multimedia capture device when received. Real-time media signals are also referred to herein as media signals for convenience.

After real-time media signals are captured, processed and/or stored by multimedia capture devices, the multimedia capture devices are configured to upload (e.g., send, transfer) one or more portions of media signals to an entity, such as a network device or a control server, within a network. The sending of one or more portions of a media signal from a multimedia capture device over the network is triggered (e.g., modified) by a transmission indicator that indicates, for example, a start transmission time and/or a transmission rate.

The transmission indicator can be defined by a transmission rule or set of transmission rules that use one or more local parameter values and/or one or more regional parameter values. Local parameter values are parameter values associated with a single multimedia capture device (e.g., disk space available on a multimedia capture device) and regional parameter values are parameter values that are associated with more than one entity in a network (e.g., total bandwidth available within a portion of a network). A local component(s) of the transmission rule(s) can be populated with the local parameter value(s), and a regional component(s) of the transmission rule(s) can be populated with the regional parameter value(s).

The uploading of media signals from one or more multimedia capture devices can be synchronously or asynchronously coordinated based on one or more transmission rules. Transmission indicators can be periodically (e.g., at specified times), dynamically, and/or asynchronously defined to trigger the uploading of media signals in response to changes in parameter values (e.g., local parameter values and/or regional parameter values) and/or transmission rules.

A transmission rule(s) can be used at the multimedia capture device or at the control server to define a transmission indicator(s) based on a parameter value(s) that is received at the control server and/or the multimedia capture device. A control server, for example, can receive one or more parameter values and can use the parameter value(s) in a transmission rule to define one or more transmission indicators. The control server can then send the transmission indicator to a multimedia capture device(s) to modify sending a media signal from the multimedia capture device to an entity within a network. In some embodiments for example, a multimedia capture device can receive one or more transmission rules and one or more parameter values. The multimedia capture device can use the parameter value(s) in the transmission rule(s) to define one or more transmission indicators that can be used at the multimedia capture device to trigger (e.g., modify) the sending of a media signal to an entity within a network.

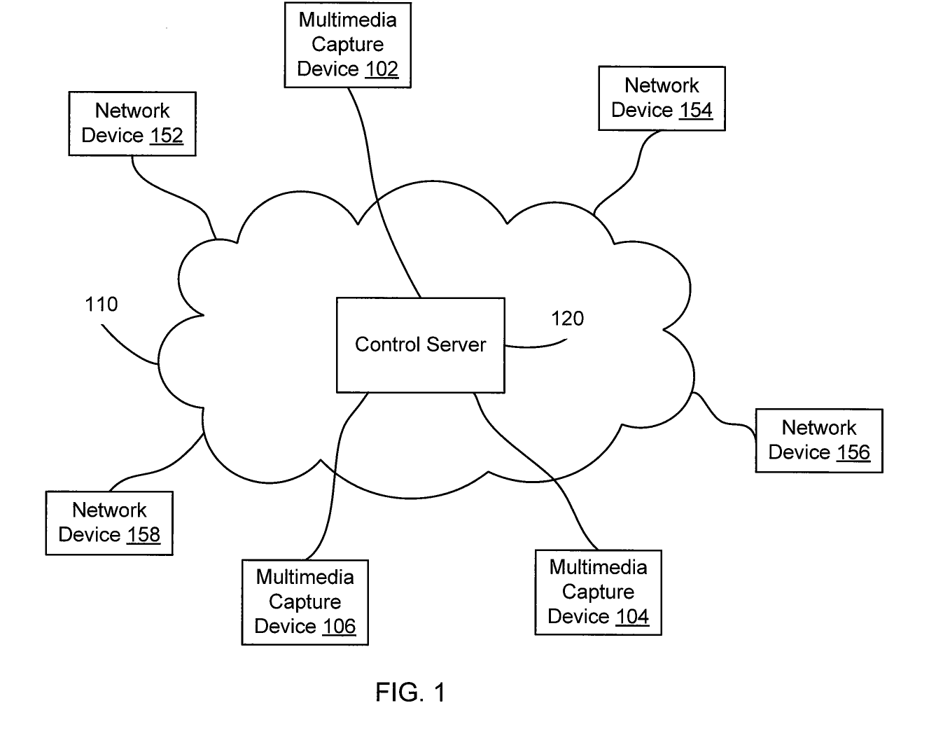

FIG. 1 is a block diagram that illustrates multimedia capture devices 102, 104, and 106 distributed across a network 1 10 and in communication with a control server 120. After a media signal(s) is captured, processed and/or stored by one or more of the multimedia capture devices 102, 104, and 106, the multimedia capture devices 102, 104, and 106 are configured to send (e.g., upload, transfer) one or more portions of the media signal(s) to an entity connected to the network 110 such as the control server 120. Several network devices 152, 154, 156, and 158 such as, for example, personal computers and/or servers are also in communication with and are configured to send and/or receive signals over the network 110. The network 110 can be any type of network including a local area network (LAN) or wide area network (WAN), implemented as a wired or wireless network in a variety of environments such as, for example, a university campus or an office complex.

In some embodiments, the multimedia capture devices 102, 104, and 106 can be dedicated (i.e., specific-purpose) devices having embedded environments (referred to as an embedded appliance). The multimedia capture devices 102, 104, and 106 can be configured to use a hardened operating system (OS) and a processor (e.g., processor system) to capture, process, store and/or send one or more real-time media signals. The hardware and software within each of the multimedia capture devices 102, 104, and 106 can be integrated into and designed specifically for capturing, processing, storing and/or sending real-time media signals. More details regarding multimedia capture devices are set forth in co-pending application entitled, “Embedded Appliance for Multimedia Capture” (Attorney Docket No.: ANYS-001/00US), which is incorporated herein by reference. In some embodiments, one or more of the multimedia capture devices 102, 104, and 106 can be a general purpose computer system (e.g., personal computer (PC) based multimedia capture device) that is configured to capture a media signal in response to a capture instruction.

The multimedia capture devices 102, 104, and 106 are configured to modify the sending/uploading of one or more portions of real-time media signals to an entity of the network 110 in response to one or more transmission indicators (e.g., start and/or stop indicators) defined at, for example, the control server 120 and/or the multimedia capture devices 102, 104, and 106. The transmission indicator can include instructions for sending one or more real-time media signals from multimedia capture device 102, for example, at a specified rate, at a specified time, over a particular network path, and to one or more specified destination entities such as one of the network devices 152, 154, 156, and 158 and/or the control server 120. The transmission indicator can include instructions that either start a transmission or modify an existing transmission already in progress. In some embodiments, the multimedia capture devices 102, 104, and 106 can be configured to immediately or periodically upload captured content unless otherwise prompted by a transmission indicator.

The multimedia capture devices 102, 104, and 106 can be prompted by a transmission indicator to send media signals after any stage of processing. For example, a multimedia capture device 102, 104, and 106 can be prompted to send to the control server 120 unsynchronized and unformatted portions of audio and digital-images signals after the signals have been compressed. The control server 120 can be configured to synchronize and format the audio and digital-image signals received from the multimedia capture device 102, 104, and 106.

The multimedia capture devices 102, 104, and 106 can be configured to upload a portion of a media signal, in response to a transmission indicator, while capturing, processing, and/or storing another portion of the same media signal. The multimedia capture devices 102, 104, and 106 can also be configured, in response to a transmission indicator, to capture, process and/or store a media signal while uploading a separate media signal captured at a different time. The multimedia capture devices 102, 104, and 106 can also be triggered to upload data associated with captured content such data as, for example, capture time, capture location, and/or speaker's name.

One or more local parameter values and/or one or more regional parameter values can be used in a transmission rule to define the transmission indicator. A portion of the transmission rule is associated with (e.g., has one or more variables that are populated by) one or more local parameter values can be referred to as a local component. Likewise a portion of the transmission rule that are associated with one or more regional parameter values can be referred to as a regional component. The local parameter value(s) can be used in the local component of the transmission rule and the regional parameter value(s) can be used in the regional component of the transmission rule to calculate or determine a result that can be used to define one or more transmission indicators.

Local parameter values are parameter values associated with a single multimedia capture device 102, 104, and 106 such as, for example, the disk space available on multimedia capture device 106. Regional parameter values are parameter values that are associated with more than one entity in a network such as the total bandwidth available within a portion of the network 110 (e.g., a portion associated with network device 156 and multimedia capture device 104). The transmission of media signals from the multimedia capture devices 102, 104, and 106 can be dynamically and asynchronously coordinated by one or more transmission rules.

Although FIG. 1 shows a single control server 120 connected with multimedia capture devices 102, 104, and 106, in some embodiments, more than one control server 120 can be connected with any combination of multimedia capture devices 102, 104, and 106. For example, more than one control server 120 can be configured to coordinate the uploading of media signals captured by multimedia capture devices 102, 104, and 106. The multimedia capture devices 102, 104, and 106 can be programmed to recognize multiple control servers 120 and can be programmed to, for example, upload one or more portions of a processed media signal to one or more control servers 120. In some embodiments, one or more functions performed by the control server 120 can be performed on one or more devices (not shown) connected to the network 110.

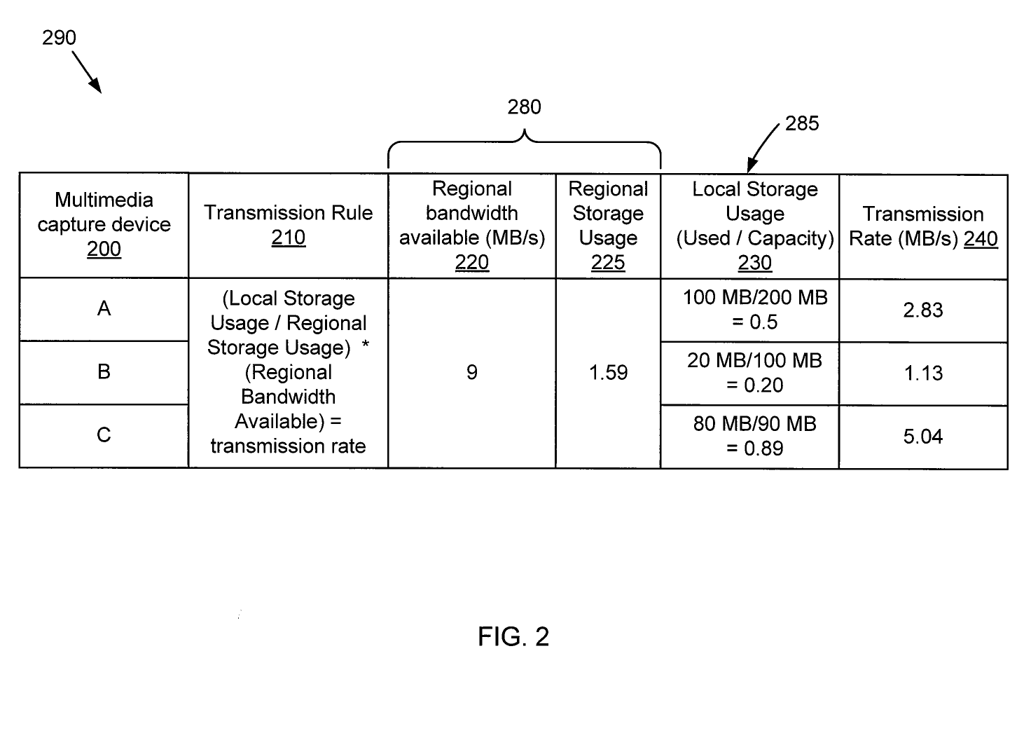

FIG. 2 shows a table 290 that illustrates an example of a transmission rule 210 that can be used to define a transmission rate 240 in megabytes per second (MB/s) for several multimedia capture devices 200. The values of the transmission rate 240 can be used to define one or more transmission indicators that can trigger the uploading of captured media content from the multimedia capture devices 200. The example in FIG. 2 can also be used to illustrate the dynamic and asynchronous coordination of the uploading by the multimedia capture devices based on the transmission rule 210. The table 290 includes a local parameter value 285 that includes local storage usage (used/capacity) 230 for each of the multimedia capture devices A, B, and C. The local storage usage 230 is an indicator of the amount of memory capacity being used by each of the multimedia capture devices 200 to store captured media signals.

The table 290 also includes regional parameter values 280 that include regional bandwidth available (MB/s) 220 and regional storage usage 225. The regional bandwidth available 220 is an overall bandwidth available for transferring captured and/or processed media signals from the multimedia capture devices A, B, or C. The regional storage usage 225 is the sum of the values of local storage usage 230 of the multimedia capture devices 200 that are associated with and are coordinated by the transmission rule 210. The regional storage usage 225 is a regional parameter value 280 that is dependent on the local storage usage 230 from local parameter values 285. In this example embodiment, each of the regional parameter values 280 is a value that corresponds with all of the multimedia capture devices 200 that are associated with transmission rule 210. In other embodiments, these regional parameter values 280 can differ among the various multimedia capture devices 200. In some embodiments, one or more regional parameter values and/or one or more local parameter values can be calculated independently of one another. In some embodiments, one or more regional parameter values can be calculated based on any combination of regional and/or local parameter values.

The values of the regional bandwidth available 220, the regional storage usage 225, and the local storage usage 230 that correspond with the multimedia capture devices 200 are used in the transmission rule 210 to calculate the transmission rates 240. For example, the transmission rate 240 for multimedia capture device A is calculated as 2.83 MB/s based on the regional bandwidth available 220 of 9 MB/s, the regional storage usage 225 as 1.59, and a local storage usage 230 value of 0.5.

In this embodiment, the regional bandwidth available 220 is allocated to the multimedia capture devices 200 for use in transferring stored media signals. In some embodiments, one or more of the multimedia capture devices 200 can be configured to use only a portion of the bandwidth that has been allocated for the transmission of captured and/or stored media signals. Also, in some embodiments, the transmission rule 210 can be configured so that not all of the regional bandwidth available 220 is allocated for use by the multimedia capture devices 200.

The transmission rule 210 shown in table 290 has a regional component and a local component. The regional component of the transmission rule 210 includes the variables that are associated with the regional parameters 280 (i.e., the regional bandwidth available 220 and the regional storage usage 225). The local component of the transmission rule 210 includes the variables that are associated with the local parameter 285 (i.e., the local storage usage capacity 230 for a multimedia capture device). The first term of transmission rule 210 (local storage usage/regional storage usage) can be regarded as a normalized storage usage value. The second term of the transmission rule 210 includes only a regional parameter (regional bandwidth available 220). The first term of the transmission rule 210 is multiplied by the second term of the transmission rule 210 to calculate the transmission rate 240.

The transmission rate 240 values can be used to define one or more transmission indicators that can cause one or more of the multimedia capture devices 200 to modify the transmission of stored media signals to an entity within a network. In some embodiments, transmission rates 240 can be used to modify directly the transfer of media signals from a multimedia capture device. In some embodiments, transmission rates 240 can be stored and used at a later to time to define a transmission indicator that modifies the transfer of a media signal(s) from one or more of the multimedia capture devices 200. The transfer of a media signal(s) is modified in the sense that its transfer rate is changed to another transfer rate—from a zero transfer rate to a non-zero transfer rate, from a non-zero transfer rate to a zero transfer rate, or from a non-zero transfer rate to a different non-zero transfer rate.

As the regional parameter values 280 and/or the local parameter values 285 change (e.g., modified, updated), the transmission rates 240 calculated using the transmission rule 210 change. The relationship in the transmission rule 210 is defined so that if and when the regional storage usage 225 increases when a local storage usage 230 value increases, the transmission rates 240 corresponding to the multimedia capture devices 200 will increase and vice versa. When the regional bandwidth available 220 and/or local storage usage 230 increases, the calculated transmission rates 240 increase and vice versa. In some embodiments, an increase in local storage usage 230 can be caused by, for example, multimedia capture device B capturing and storing media signals of a presentation. A decrease in local storage usage 230 can be caused by, for example, multimedia capture device B uploading signals to an entity in a network. In some embodiments, a decrease in regional bandwidth available 220 can be caused by a failure of a portion of a network.

The transmission rates 240 for each of the multimedia capture devices 200 can be calculated in a coordinated and/or synchronous fashion because the transmission rates 240 are calculated using a common transmission rule 210 with a regional component that is associated with all of the multimedia capture devices 200. The transmission rate 240 that corresponds with an individual multimedia capture device 200, however, can also be asynchronously calculated because the transmission rule 210 also includes a local component that can be associated with a single multimedia capture device 200.

A change in a single local parameter value 285, for example, can cause a change in transmission rate 240 for a single multimedia capture device 200 according to the transmission rule 210. As a specific example, if the local storage usage 230 of multimedia capture device B is increased from 0.2 to 0.3 because multimedia capture device B has captured more media signals than it has uploaded, the transmission rate 240 based on the increased value will be changed from 1.13 MB/s to 1.60 MB/s. In this example, the transmission rate 240 for multimedia capture device B was changed by the local change in storage usage 230 and was calculated using the transmission rule 210.

In some embodiments, a change in one of the regional parameter values 280 can cause a synchronous (and coordinated) change to the transmission rates 240 for all of the multimedia capture devices 200. For example, a decrease in the regional bandwidth available 220 can cause a decrease in the transmission rates 240 for multimedia capture devices A, B, and C. The decrease in regional bandwidth available 220 can be caused by, for example, increased bandwidth usage by a network device other than the multimedia capture devices 200. The regional bandwidth available 220 can be, for example, increased based on a bandwidth limit increase that can be defined by network administrator.

In some embodiments, a change in a value of local storage usage 230 for a single device can cause one or more asynchronous and/or synchronous changes at different (e.g., staggered) times. For example, a change in the value of local storage usage 230 of multimedia capture device C can be detected/measured and can cause an asynchronous change in the transmission rate 240 of multimedia capture device C calculated at a first time using the transmission rule 210. In this embodiment, the change is asynchronous in the sense that the transmission rate 240 for only multimedia capture device C is recalculated. In some embodiments, the detection/measurement and calculation times can be performed at different times. At a second and later time, the change in the local storage usage 230 for multimedia capture device C can cause the value of the regional storage usage 225 to be recalculated. The transmission rates 240 for all of the multimedia capture devices 200 can then be synchronously recalculated (e.g., at a third time) based on the new value for the regional storage usage 230. In some embodiments, the transmission rates 240 for all of the multimedia capture devices 200 can then be asynchronously recalculated based on the new value for the regional storage usage 230. In some embodiments, the detection and calculation can be performed at a processor of a control server based on, for example, a user-defined, periodic interval.

In some embodiments, the transmission rates 240 can be dynamically calculated as changes in local parameter values 285 and/or regional parameter values 280 are detected. An indicator of the change can trigger a calculation (e.g., recalculation) of one or more of the transmission rates 240. The change can be caused by, for example, an input value specified by a network administrator or a change based on a measurement of a parameter value. For example, the transmission rule 210 can be used to calculate (e.g., update, modify) a transmission rate 240 for one or more of the multimedia capture devices 200 when any change to the local parameter value 285 and/or regional parameter values 280 is detected.

The calculation of transmission rates 240 can also be triggered, in some embodiments, when a change to one or more of the local parameter values 285 and/or one or more of the regional parameter values 280 satisfies a threshold value. For example, a transmission rate 240 for multimedia capture device B can be calculated only when local storage usage 230 exceeds 0.40. In some embodiments, one or more different threshold values can be used to trigger the calculations of the transmission rates 240 of each of the multimedia capture devices 200. For example, the calculation of the transmission rate 240 for multimedia capture device A can be triggered based on a different threshold value than a threshold value that is used to trigger the calculation of the transmission rate 240 of multimedia capture device B.

In some embodiments, the transmission rates 240 corresponding to the multimedia capture devices 200 can be periodically calculated/updated in response to a periodic event. For example, the transmission rates 240 can be calculated when the regional bandwidth available 220 is periodically (e.g., at a specified time or time interval) measured. As another example, the transmission rates 240 can be calculated when the regional storage usage 225 changes.

In some embodiments, the transmission rates 240 for the multimedia capture devices 200 can be calculated (e.g., modified, updated) at different times depending on any combination of threshold values and/or periodic measurements. For example, a transmission rate 240 corresponding to multimedia capture device A can be updated every five minutes while the transmission rate 240 for multimedia capture device B can be updated when a change in any of the regional parameter values 280 and/or local parameter values 285 is detected. The updated transmission rates 240 can be used to define transmission indicators that correspond with and can be sent to multimedia capture devices A and B.

The transmission rule 210 can also be modified at any time (e.g., dynamically and/or at specified times). A change in a transmission rule 210 can trigger the calculation of one or more transmission rates 240 for the multimedia capture devices. For example, if a multiplication factor is included in the transmission rule 210, the transmission rates 240 can be updated based on the modification to the transmission rule 210.

Transmission indicators that are defined based on the transmission rates 240 can also be defined at specified times (e.g., periodically) and/or dynamically. For example in some embodiments, transmission rates 240 can be calculated and updated continuously while transmission indicators can be defined only when a significant change in a transmission rate 240 is detected.

Although the example in FIG. 2 illustrated a transmission rule 210 based on the regional bandwidth available 220, the regional storage usage 225, and the local storage usage 230, transmission rules can be based on any combination of local and/or regional parameters that can be measured and/or specified by, for example, a network administrator and/or user. In some embodiments, a transmission rule(s) can be based on any combination of algorithms (e.g., algorithm based on a ticket or token), look-up tables, mathematical equations/relationships, threshold conditions (e.g., threshold limit values), specific values, boolean logic, or random values. A transmission rule can include any combination of local and/or regional components. In some embodiments, one or more portions of a transmission rule can be modified based on a change in a parameter value such as a regional parameter value. The method for modifying the transmission rule triggered by a change in a parameter value can be included in the transmission rule itself or a separate rule (e.g., second transmission rule).

Also, in some embodiments, more than one transmission rule (e.g., a library of transmission rules) can be used to calculate one or more values that can be used as or used to define a transmission indicator. In some embodiments, a specific transmission rule can be selected from a library of transmission rules to define a transmission indicator based on, for example, a change in a local parameter value.

In some embodiments, a transmission rule can be used to generate one or more values that are used as guidelines in defining a transmission rule. For example, a multimedia capture device such as multimedia capture device A can be configured to transmit media signals at a rate that is different than the transmission rate 240 calculated based on the transmission rule 210. In some embodiments for example, the transmission rate 240 calculated based on the transmission rule 210 can be used as, for example, a maximum transmission rate value by multimedia capture device A. Multimedia capture device A can use a different local rule stored at multimedia capture device A to trigger, within the maximum transmission rate value, the transmission of media signals to an entity within a network.

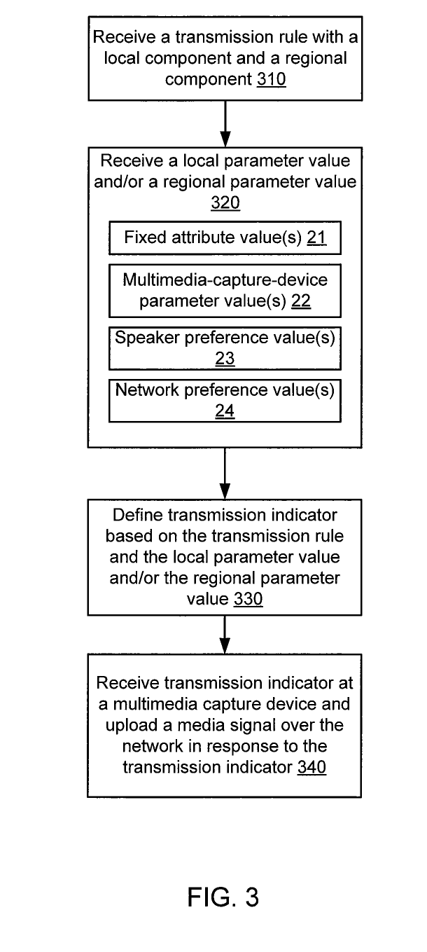

FIG. 3 shows a flowchart that illustrates a method for using a transmission rule to modify the uploading of a media signal from a multimedia capture device. As shown in FIG. 3, a transmission rule that has a local component and regional component is received at 310. The transmission rule can be received at, for example, a multimedia capture device or a control server. The transmission rule can be based on any combination of regional and local parameters and based on logic, mathematical equations, and/or algorithms. The local component of the transmission rule is associated with one or more local parameter values and the regional component of the rule is associated with one or more regional parameter values.

As shown in FIG. 3, a local parameter value and/or a regional parameter value is received at 320. The parameter value(s) at 320 can be, as an illustrative example(s), a fixed attribute value(s) 21, a multimedia-capture-device parameter value(s) 22, a speaker preference value(s) 23, and/or a network preference value(s) 24. These example parameter value(s) can be regional parameter values that are associated with, for example, more than one device within a network and/or a local parameter value that is associated with, for example, only a single multimedia capture device.

The fixed attribute value(s) 21 is, for example, a physical limitation of a device or a network. A fixed attribute value(s) 21 can be a local fixed attribute value such as a maximum amount of storage available on a multimedia capture device or a regional fixed attribute value such as a maximum amount of bandwidth available on a network. A local storage capacity of a multimedia capture device measured at a given time is an example of the multimedia-capture-device parameter value 22. The speaker preference value 23 can be, for example, a local preference value defined by a professor that indicates when a captured classroom presentation should be made available to students. The speaker preference value 23 can influence the time or rate at which captured media signals are uploaded by a multimedia capture device. The network preference value 24 (e.g., network black-out dates, or information technology (IT) locks and limits) can be a regional preference value defined by, for example, an administrator that is related to, for example, a portion of a network. The network preference value 24 can be a general policy set by an administrator that, for example, requires that all media signals being uploaded by multimedia capture devices not exceed a specified transfer rate or disallows the uploading of all media signals on a particular day and/or time.

A transmission indicator is defined based on the transmission rule and the local parameter value and/or regional parameter value at 330. The local parameter value(s) can be used in the local component of the transmission rule and the regional parameter value(s) can be used in the regional component of the transmission rule to calculate a result that can be used to define a transmission indicator. The result from the transmission rule can be used as the transmission indicator or can be used to define a transmission indicator, for example, at a later time.

The transmission indicator can include, for example, a transmission rate (e.g., transmission rate in kilobytes per second), a transmission start prompt (e.g., a delayed transmission start time), a transmission destination (e.g., internet protocol address of a destination entity or network device 450) or a transmission stop prompt (e.g., an immediate stop upload indicator). The transmission indicator can be defined, for example, to cause a multimedia capture device to send/upload one or more captured/stored media signals to a control server or another entity (e.g., network device) connected to a network. The transmission indicator can be defined to modify an existing transmission by a multimedia capture device. For example, the transmission indicator can be defined to decrease the transmission rate of a multimedia capture device that is already transmitting media signals over a portion of a network.

After the transmission indicator has been defined at 330, the transmission indicator is received at a multimedia capture device and causes the multimedia capture device to upload a media signal over the network at 340. The multimedia capture device can use the transmission indicator to schedule an upload that can occur, for example, at a later time according to a local schedule stored on the multimedia capture device.

Although the embodiment illustrated in FIG. 3 includes a particular order for blocks 310-340, the order illustrated in the flowchart is by way of example only and the blocks and/or steps within blocks do not have be executed in that particular order. For example, the parameter value(s) received at 320 can be received before the transmission rule 310 has been received at 310. In some embodiments, the transmission indicator can be initially defined based on only a fixed attribute value(s) 21 at a first time and the transmission indicator can be modified at a second a later time after a network preference value(s) 24 has been received.

In some embodiments, the flowchart shown in FIG. 3 can be modified so that the transmission indicator can be defined when a change in a local parameter value(s) and/or regional parameter value(s) has been detected. The defining of the transmission indicator can be triggered by an indicator of a change. In some embodiments, a transmission indicator can be defined when a transmission rule has been modified.

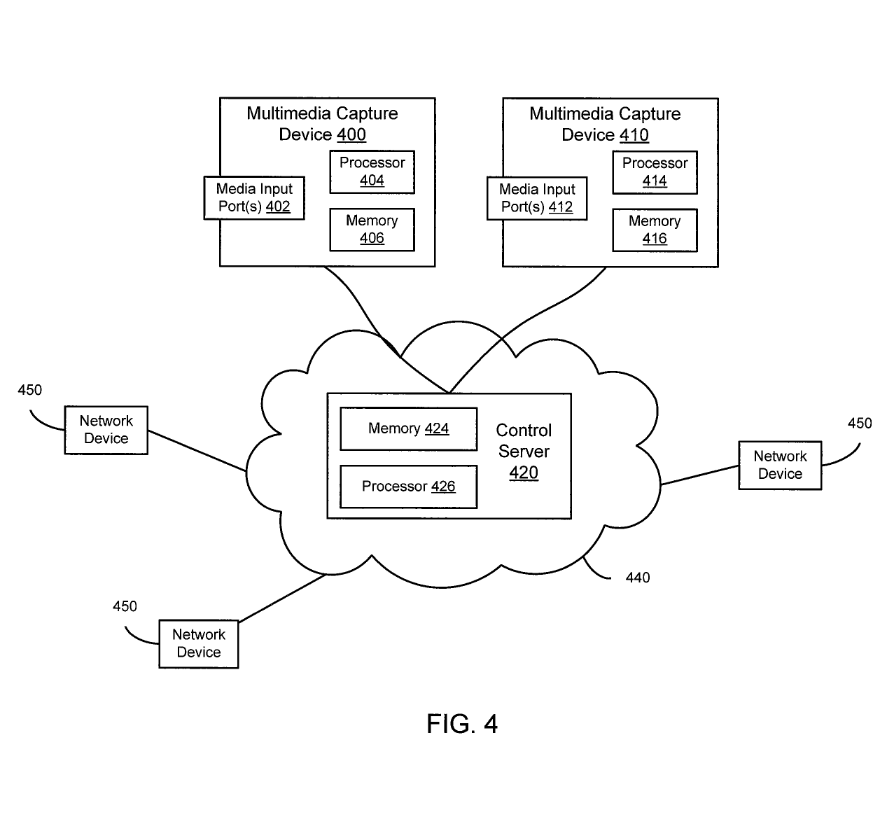

FIG. 4 is a schematic system block diagram that illustrates multimedia capture devices 400 and 410 with a control server 420 in communication over a network 440. The control server 420 includes a memory 424 and a processor 426. Several network devices 450 such as, for example, computers and servers are also in communication with and configured to send and/or receive signals over the network 440.

Multimedia capture device 400 includes a media input port(s) 402, a processor 404 and a memory 406. The multimedia capture device 400 captures real-time media signals acquired by various electronic devices (e.g., video camera) via the media input port(s) 402 in response to start capture and stop capture indicators generated by, for example, a scheduler module within the processor 404 based on a capture schedule. In some embodiments, the scheduler module (not shown) can be included in the multimedia capture device 400 as a separate component. The processor 404 can capture and/or process (e.g., encode, compress, etc.) the media signals and can subsequently store them in the memory 406. Multimedia capture device 410 also includes a media input port(s) 412, a processor 414, and a memory 416. Although the remainder of the description in connection with FIG. 4 focuses on the functions associated with multimedia capture device 400, these functions can be equivalently performed using multimedia capture device 400 and/or 410.

Although only a single media input port 402 is included in the diagram of the multimedia capture device 400, the media input port 402 is representative of the many types of media input ports 402 that can be included in the multimedia capture device 400. For example, the media input port 402 can include an audio input port(s), a visual-capture input port(s), a video input port(s) or a digital-image input port(s). The audio input port(s) can be, for example, an RCA stereo audio input port(s), a ¼″ jack stereo audio input port(s), XLR input port(s) and/or a universal serial bus (USB) port(s). The visual-capture input port(s) receives a digital or analog video-graphics-array (VGA) signal through, for example, a VGA input port(s), digital visual interface (DVI) input port(s), extended graphics array (XGA) input port(s), HD-15 input port(s) and/or BNC connector port(s). The video input port(s) can receive motion video signals from devices such as video cameras via an input port(s) that includes, but is not limited to, an s-video input port(s), composite video input port(s) and/or component video input port(s). The digital-image input port(s) can capture digital-images via an input port(s) such as an Ethernet port(s) and/or a USB port(s). The digital-images can be acquired using, for example, a digital camera or a web camera.

The media signals captured by the media input port 402 can be received as one or more analog signals and/or one or more digital signals. Also, more than one media input port 402 can be included in the multimedia capture device 400 and connected to the processor 404 and/or the memory 406. Although not shown, when more than one media input port 402 is included in the multimedia capture device 400, each media input port 402 can be controlled and/or operated independently or in tandem with other media input port(s) 402. Similarly, media input port 412 is representative of the many types of media input ports 412 that can be included in multimedia capture device 410.

The multimedia capture devices 400 and 410 are configured to send/upload one or more captured/stored media signals to the control server 420 or another entity (e.g., network device 450) within the network 440 in response to a transmission indicator. If sent to the control server 420, the control server 420 can store the media signal(s) in the memory 424 and later distribute the media signal(s) to, for example, a user (not shown). In some embodiments, the control server 420 sends the media signals to, for example, a course management system (not shown) where the media signals are distributed to, for example, a user (not shown).

The control server 420 can be configured to define one or more transmission indicators at the control server 420 according to one or more transmission rules and local and/or regional parameter values. Specifically, the transmission indicators can be defined at the processor 426 of the control server 420. For example, a transmission rule can be stored in the memory 424 of the control server 420 and accessed by the processor 426 when defining a transmission indicator. Local and/or regional parameter values can also be received by the processor 426 and/or stored in the memory 424. If stored in the memory 424, the processor 426 can be configured to access the parameter values from the memory 424. One or more regional parameter values can be, for example, measured and/or received at the control server 420 and/or one or more local parameter value can be received from, for example, multimedia capture device 400.

The control server 420 can be configured to store and use one or more transmission rules that correspond to one or more of the multimedia capture devices 400 and 410. For example, the control server 420 can be configured to define a transmission indicator for multimedia capture device 410 based on combination of a first transmission rule that is associated with both multimedia capture devices 400 and 410 (also referred to as a regional transmission rule) and a second transmission rule that is configured specifically for multimedia capture device 410 (also referred to as a local transmission rule). The first and/or second transmission rules can be configured with local and/or regional components.

Conflicts, if they arise, between the first transmission rule and the second transmission rule can be resolved at the control server 420. The conflicts can be resolved based on rules included in the transmission rule(s) and/or a separate rules-based algorithm at the control server 420 that is defined by, for example, a network administrator or a user. For example, a conflict can be resolved by a rules-based algorithm included in the control server 420 that, for example, automatically gives a first transmission rule precedent over a second transmission rule. In some embodiments, a conflict can be resolved by calculating and using an average value from two or more conflicting transmission rules. In some embodiments, multimedia capture device 400 and/or 410 can also be configured to store, use, and/or resolve conflicts between one or more transmission rules.

One or more transmission indicators can also be defined at either of the multimedia capture devices 400 or 410 according to one or more transmission rules and local and/or regional parameter values. For example, a transmission rule can be stored in the memory 406 of the multimedia capture device 400 and accessed by the processor 404. Local and/or regional parameter values can be received by the processor 404 and/or stored in the memory 406. If stored in the memory 406, the processor 404 can be configured to access the parameter values from the memory 406. One or more local parameter values can be, for example, measured at the multimedia capture device 400 and/or one or more regional parameter values can be measure at and received from, for example, control server 420. Multimedia capture device 400 can be configured to access and process the parameter value(s) and transmission rule(s) when defining one or more transmission indicators for multimedia capture device 400.

In some embodiments, a transmission indicator can be defined at the control server 420 based on, for example, a first transmission rule (e.g., regional transmission rule) and sent to, for example, multimedia capture device 400. Multimedia capture device 400 can modify the transmission indicator based on a second transmission rule (e.g., local transmission rule) that is stored at multimedia capture device 400. The second transmission rule can be, for example, loaded directly onto the multimedia capture device 400 or sent from, for example, the control server 420. The second transmission rule can be, for example, a regional transmission rule that is associated with one or more multimedia capture devices or a local transmission rule that is associated with only multimedia capture device 400.

One or more regional parameter value(s) can be measured and/or received at the control server 420 periodically based on, for example, a schedule or a timer. For example, network preferences can be periodically retrieved by the control server 420 or available network bandwidth can be periodically measured by the control server 420. The regional parameter values and/or indicators of the regional parameter values can be, for example, stored and used only at the control server 420 or broadcast to the multimedia capture devices 400 and 410 for use. In some embodiments, control server 420 can be configured to send one or more regional parameter values to, for example, multimedia capture device 400 in response to a request from multimedia capture device 400. In some embodiments, one or more regional parameter value(s) and/or indicator(s) of regional parameter value(s) can be measured and/or sent only when a change in a regional parameter value(s) is detected.

One or more local parameter value(s) can be measured and/or received at, for example, multimedia capture device 400 periodically based on, for example, a schedule or a timer. Multimedia capture device 400 can periodically, for example, measure its disk capacity and/or receive an update to a speaker preference value that is associated with a media signal(s) being captured by the multimedia capture device 400. In some embodiments, the speaker preference value can be associated with, for example, a capture instruction that is configured to prompt the multimedia capture device 400 to capture a media signal. The multimedia capture device 400 can be configured to, for example, retrieve the speaker preference value when the multimedia capture device 400 will define a transmission indicator. More details regarding capture instructions are set forth in co-pending application entitled, “Dynamic Triggering of Media Signal Capture” (Attorney Docket No.: ANYS-003/00US), which is incorporated herein by reference.

Multimedia capture device 400 can be configured, in some embodiments, to send one or more local parameter value(s) to the control server 420. In some embodiments, multimedia capture device 400 can be configured to send one or more local parameter values to the control server 420 in response to a request from the control server 420. In some embodiments, one or more local parameter value(s) can be measured and/or sent only when a change in a local parameter value is detected at, for example, multimedia capture device 400.

The defining of one or more transmission indicators at multimedia capture devices 400, multimedia capture devices 410, and/or the control server 420 can be triggered by, for example, a change in a local parameter value and/or a regional parameter value. The defining can be triggered, for example, only when a threshold condition or combination of threshold conditions are satisfied. The threshold conditions can be based on, for example, a network preference that can be defined by, for example, a network administrator. The threshold condition(s) can be stored in, for example, the memory 406 of multimedia capture device 400 and/or the memory 424 of control server 420. In some embodiments, the defining of one or more transmission indicators at multimedia capture device 400, multimedia capture device 410, and/or the control server 420 can be triggered by, for example, a schedule or a timer.

In some embodiments, the control server 420, for example, can store and use a first transmission rule that can be used in defining a second transmission rule that can be, for example, used at multimedia capture device 400. For example, control server 420 can store a first transmission rule with a local and/or a regional component that is used to calculate, for example, a transmission rate maximum value. The first transmission rule can be stored in the memory 424 of the control server 420 and the transmission rate maximum value can be calculated at the processor 426. The first transmission rule can use local and/or regional parameter values to calculate the transmission rate maximum value. The transmission rate maximum value can be sent from the control server 420 to the multimedia capture device 400.

The transmission rate maximum value can be used at the multimedia capture device 400 as a second transmission rule to limit the rate of transmission of media signals over the network 440 from multimedia capture device 400. In some embodiments, the multimedia capture device 400 can be configured to transmit any captured and/or stored media signals to the control server 420 at a rate that is below the transmission rate maximum value. The multimedia capture device 400 can transmit media signals based on a transmission indicator defined at the multimedia capture device 400 and based on the transmission rate maximum value.

In some embodiments, the first transmission rule can be an algorithm that can be used to define a second transmission rule that includes, for example, a regional component and/or a local component. One or more portions of the algorithm can be included as regional and/or local components that use regional and/or local parameter values to define the second transmission rule. The second transmission rule can be used to define for example a transmission indicator. In some embodiments, the first transmission rule can be used at the multimedia capture device 400 to define a second transmission rule that can be used at the control server 420 to define, for example, a transmission indicator for one or more multimedia capture devices.

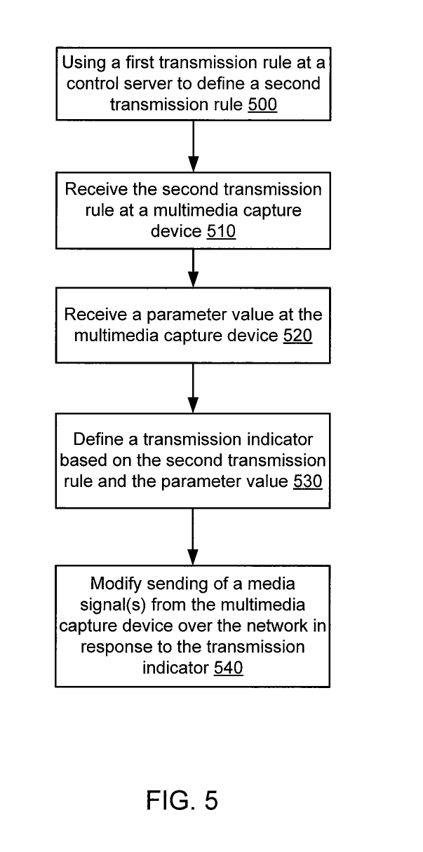

FIG. 5 shows a flowchart that illustrates a method for defining a second transmission rule based on first transmission rule. The second transmission rule and/or first transmission rule can include a local component and/or a regional component. In this embodiment, the first transmission rule is used to define a second transmission rule at a control server at 500. The first transmission rule can be, for example, a transmission rule with a regional component and a local component. Local and/or regional parameter values can be used in the first transmission rule to define the second transmission rule. The second transmission rule can include, for example, a threshold value that can be used by, for example, a multimedia capture device to define a transmission indicator or can be used as an upload limiting value (e.g., maximum transmission rate). In some embodiments, the second transmission rule can be, for example, a complex transmission rule that includes local and/or regional components.

The second transmission rule is received at a multimedia capture device at 510 and a parameter value is received at the multimedia capture device at 520. The parameter value is a value that can be used in the second transmission rule to define a transmission indicator at 530. The parameter value can be, for example, a local parameter value and/or a regional parameter value that is associated with the second transmission rule. As shown in FIG. 5, the multimedia capture devices uses the transmission indicator to modify the sending of a media signal(s) in response to the transmission indicator at 540. Although in FIG. 5, the second transmission rule was defined at the control server and sent to the multimedia capture device, in some embodiments, the a transmission rule can be defined at a multimedia capture device using a different transmission rule.

In conclusion, among other things, an apparatus and method for uploading media signals captured on a multimedia capture device is described. While various embodiments of the invention have been described above, it should be understood that they have been presented by way of example only and various changes in form and details may be made. For example, one or more transmission rules can be stored in a remote memory location (or multiple memory locations) such as a server. The transmission rules can be accessed by a multimedia capture device and/or a control server when needed to define a transmission indicator.

What is claimed is:

1. A method, comprising:
receiving, at a control server, at least one of a local parameter value or a regional parameter value, the local parameter value being associated with a multimedia capture device within a network, the regional parameter value being associated with at least two entities of the network;
receiving a transmission rule having a local component and a regional component, the local component being associated with the multimedia capture device, the regional component being associated with the at least two entities of the network; and
sending a transmission indicator from the control server to the multimedia capture device, the transmission indicator being based on the transmission rule and the at least one of the local parameter value or the regional parameter value, the transmission indicator being configured to cause the multimedia capture device to modify sending a media signal over the network.

2. The method of claim 1, further comprising:
detecting a change in at least one of the regional parameter value or the local parameter value; and
modifying at least one of the local component or the regional component in response to the change.

3. The method of claim 1, wherein the transmission rule is based on at least one of boolean logic, a threshold condition, a look-up table, or a mathematical relationship.

4. The method of claim 1, wherein the regional parameter value is calculated based on the local parameter value.

5. The method of claim 1, wherein the first multimedia capture device is a first multimedia capture device,
the method, further comprising:
receiving a local parameter value associated with a second multimedia capture device; and
sending a second transmission indicator to the second multimedia capture device, the second transmission indicator being defined based on the transmission rule and the at least one of the second local parameter value associated with the first multimedia capture device or the regional parameter value.

6. The method of claim 1, wherein the local component is based on at least one of a network preference, a multimedia capture device parameter, a venue preference, a speaker preference, or a fixed attribute associated with the multimedia capture device.

7. The method of claim 1, wherein the regional component is based on at least one of a network preference, a venue preference, a speaker preference, or a fixed attribute associated with a venue.

8. The method of claim 1, wherein the local component is included in a plurality of local components, each local component from the plurality of local components is associated with at least one transmission rule, the regional component is defined based on the plurality of local components.

9. The method of claim 1, wherein the media signal is at least one of an audio signal, a video signal, a visual-capture signal or a digital-image signal.

10. The method of claim 1, wherein the multimedia capture device is at least one of a specific-purpose embedded appliance having an embedded environment or a general purpose computer system configured for media signal capture.

11. A method, comprising:
receiving a first transmission rule at a control server, the first transmission rule being associated with the control server;
defining a second transmission rule based on the first transmission rule; and
sending the second transmission rule from the control server to a multimedia capture device within the network, the multimedia capture device configured to cause the multimedia capture device to modify sending a media signal over the network based on the second transmission rule.

12. The method of claim 11, further comprising receiving a regional parameter value, the regional parameter value being associated with at least two entities of the network, the defining includes defining based on the regional parameter value.

13. The method of claim 11, wherein the second transmission rule is based on a fixed attribute associated with the multimedia capture device.

14. The method of claim 11, further comprising:
receiving a regional parameter value, the regional parameter value is associated with the at least two entities of the network, the defining includes defining based on the regional parameter value, the regional parameter value including the local parameter value.

15. The method of claim 11, further comprising:
receiving a regional parameter value, the regional parameter value is associated with at least two entities of the network; and
detecting a change in the regional parameter value, the defining includes defining in response to the change.

16. The method of claim 11, further comprising detecting a change in the first transmission rule, the defining includes defining in response to the change.

17. The method of claim 11, the method, further comprising:
defining a third transmission rule based on the first transmission rule; and
sending the third transmission rule to a second multimedia capture device.

18. The method of claim 11, wherein the media signal is at least one of an audio signal, a video signal, a visual-capture signal or a digital-image signal.

19. The method of claim 11, wherein the multimedia capture device is at least one of a specific-purpose embedded appliance having an embedded environment or a general purpose computer system configured for media signal capture.

20. An apparatus, comprising:
a memory configured to store a transmission rule having a local component and a regional component, the local component being associated with a multimedia capture device, the regional component being associated with the at least two entities of the network; and
a processor configured to receive at least one of a local parameter value or a regional parameter value, the local parameter value being associated with a multimedia capture device, the regional parameter value being associated with at least two entities of a network, the processor configured to send a transmission indicator to the multimedia capture device, the transmission indicator being based on the transmission rule and the at least one of the local parameter value or the regional parameter value, the transmission indicator being configured to cause the multimedia capture device to modify a transmission of a media signal over the network.

21. The apparatus of claim 20, wherein the processor is configured to detect a change in the at least one of the local parameter value or the regional parameter value, the transmission indicator is defined in response to the change.

22. The apparatus of claim 20, wherein the memory and the processor are integrated into a control server.

23. The apparatus of claim 20, wherein the multimedia capture device is at least one of a specific-purpose embedded appliance having an embedded environment or a general purpose computer system configured for media signal capture.

24. The apparatus of claim 20, wherein the media signal is at least one of an audio signal, a video signal, a visual-capture signal or a digital-image signal.

25. A computer program stored on a computer-readable medium, the computer program comprising:
a first receiving instruction to receive, at a control server, at least one of a local parameter value or a regional parameter value, the local parameter value being associated with a multimedia capture device within a network, the regional parameter value being associated with at least two entities of the network;
a second receiving instruction to receive a transmission rule having a local component and a regional component, the local component being associated with the multimedia capture device, the regional component being associated with the at least two entities of the network; and
a sending instruction to send a transmission indicator from the control server to the multimedia capture device, the transmission indicator being based on the transmission rule and the at least one of the local parameter value or the regional parameter value, the transmission indicator being configured to cause the multimedia capture device to modify sending a media signal over the network.
